(19) United States
(12) Patent Application Publication
(10) Pub. No.: US 2011/0070051 A1
(43) Pub. Date: Mar. 24, 2011

(54) FASTENER

(76) Inventor: Peter J.H. CHANG, Taiwan (TW)

(21) Appl. No.: 12/687,297

(22) Filed: Jan. 14, 2010

(30) Foreign Application Priority Data
Sep. 18, 2009 (TW) 098217281

(51) Int. Cl. F16B 23/00

(52) U.S. Cl. 411/405

(57) ABSTRACT

A fastener includes a socket-engaging part and a securing part. The socket-engaging part has an external surrounding surface having at least one planar surface region and formed with grooves. Edges of the grooves and the planar surface region are disposed on an imaginary hexagonal prism, in a manner that the socket-engaging part can be sleeved in a hexagonal socket wrench. One of the edges of each groove contacts a respective one of inner surface portions of the hexagonal socket wrench, and the planar surface region contacts one of the inner surface portions of the hexagonal socket wrench when the hexagonal socket wrench is sleeved on and rotated to drive rotation of the socket-engaging part. An imaginary circumscribed cylinder of the external surrounding surface has a diameter slightly shorter than that of a receiving hole of a spline socket wrench, so that the socket-engaging part can be sleeved in and driven to rotate by the spline socket wrench.

### BACKGROUND OF THE INVENTION

1. Field of the Invention

The invention relates to a fastener, more particularly to a fastener adapted to be driven rotatably by a socket wrench.

2. Description of the Related Art

A fastener, such as a bolt or a nut, is generally used with a hexagonal wrench or a hexagonal socket wrench. Taiwanese Utility Model No. 0213143 discloses a nut that has an outer surrounding surface formed with engaging grooves, and a spline socket wrench that has an inner surface provided with engaging keys. When the socket wrench is sleeved on the nut, the engaging keys of the socket wrench engage respectively the engaging grooves of the nut, so that the nut can be driven rotatably by the socket wrench. However, such nut can only be used with the abovementioned spline socket wrench having engaging keys that correspond in number and in structure to the engaging grooves of the nut rather than an ordinary socket wrench.

### SUMMARY OF THE INVENTION

Therefore, the object of the present invention is to provide a fastener that can be driven rotatably by either a spline socket wrench or a normal hexagonal socket wrench.

Accordingly, a fastener of the present invention is adapted to be driven rotatably by any one of a spline socket wrench and a hexagonal socket wrench. The spline socket wrench has an annular inner surface that defines a receiving hole, and a plurality of angularly spaced-apart keys protruding in radial inward directions from the annular inner surface. The hexagonal socket wrench has six inner surface portions that cooperatively define a hexagonal receiving space. The fastener comprises a socket-engaging part having an external surrounding surface that surrounds an axis and that has at least one planar surface region, and a plurality of angularly spaced-apart grooves that are formed in the external surrounding surface and that extend parallel to the axis. One of the grooves is formed adjacent to the planar surface region. Each of the grooves has opposite edges parallel to the axis. The edges of the grooves and the planar surface region are disposed on an imaginary hexagonal prism slightly smaller than the receiving space of the hexagonal socket wrench, thereby permitting the socket-engaging part to be sleeved in the hexagonal socket wrench. One of the edges of each of the grooves is adapted to contact a respective one of the inner surface portions of the hexagonal socket wrench, and the planar surface region is adapted to contact one of the inner surface portions of the hexagonal socket wrench when the hexagonal socket wrench is sleeved on and rotated to drive rotation of the socket-engaging part. An imaginary circumscribed cylinder of the external surrounding surface has a diameter slightly shorter than that of the receiving hole of the spline socket wrench, thereby permitting the socket-engaging part to be sleeved in the spline socket wrench in a manner that each of the keys of the spline socket wrench is retained in a respective one of the grooves of the socket-engaging part. The fastener further comprises a securing part connected to the socket-engaging part and formed with a screw thread.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a spline socket wrench, a hexagonal socket wrench and a first preferred embodiment of a fastener according to the invention;

FIG. 2 is a top view of the first preferred embodiment;

FIG. 3 is a side view of the first preferred embodiment;

FIG. 4 is a cross-sectional view of the first preferred embodiment sleeved in the spline socket wrench;

FIG. 5 is another cross-sectional view of the first preferred embodiment sleeved in the hexagonal socket wrench; and

FIG. 6 is a perspective view of a second preferred embodiment of the fastener according to the invention.

### DETAILED DESCRIPTION OF THE PREFERRED EMBODIMENTS

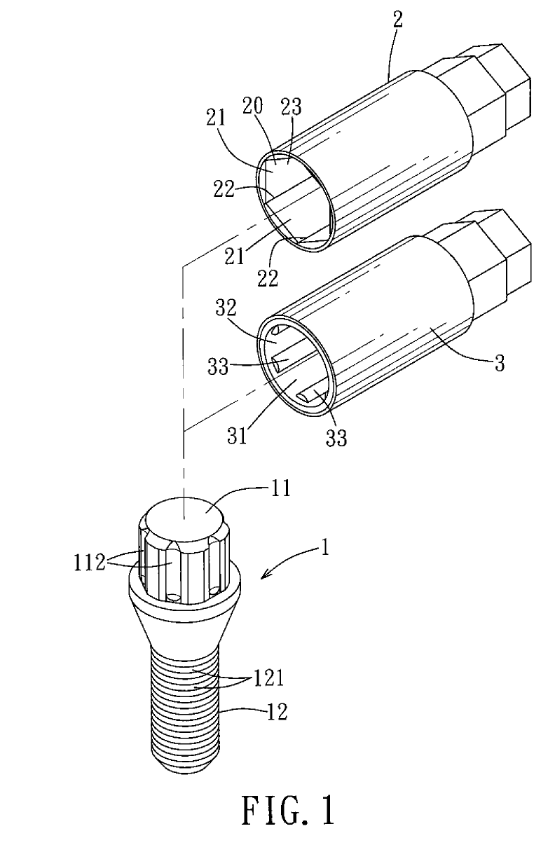

As shown in FIGS. 1, 4 and 5, the fastener 1 according to the present invention is adapted to be driven rotatably by any one of a hexagonal socket wrench 2 and a spline socket wrench 3, and is adapted to be used for securing a vehicle wheel to a wheel axle. The hexagonal socket wrench 2 has an inner surface 20 having six inner surface portions 21 that cooperatively define a hexagonal receiving space 23. The spline socket wrench 3 has an annular inner surface 32 that defines a receiving hole 31, and a plurality of angularly spaced-apart keys 33 that protrude in radial inward directions from the annular inner surface 32.

The fastener 1 comprises a socket-engaging part, and a threaded securing part connected to the socket-engaging part. Referring to FIGS. 1 to 3, the first preferred embodiment of the fastener 1 is configured as a bolt having a bolt head 11 that serves as the socket-engaging part, and a shank segment 12 that serves as the securing part and that has an external screw thread 121 formed on an outer surface of the shank segment 12.

In this embodiment, the socket-engaging part has an external surrounding surface 110 that surrounds an axis (L) and that has a plurality of main surface portions 113 and a plurality of bridging surface portions 115 that are alternatingly arranged (i.e., each of the bridging surface portions 115 interconnects an adjacent pair of the main surface portions 113). The socket-engaging part further has a plurality of angularly spaced-apart grooves 112 that are formed respectively in the main surface portions 113 and that extend parallel to the axis (L). Each of the grooves 112 has opposite edges parallel to the axis (L). In this embodiment, each of the main surface portions 113 has a pair of planar surface regions 114 formed circumferentially adjacent to and at opposite sides of a corresponding one of the grooves 112.

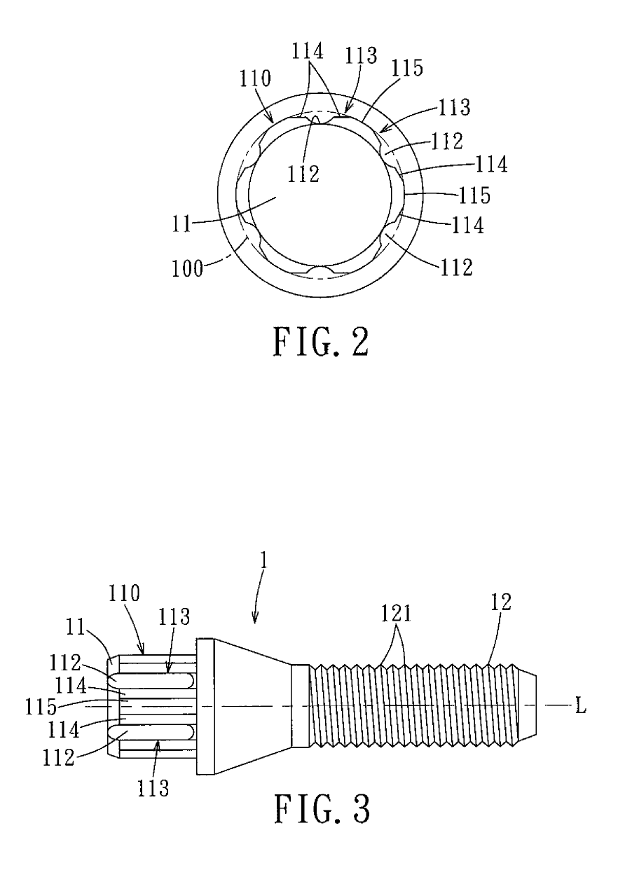

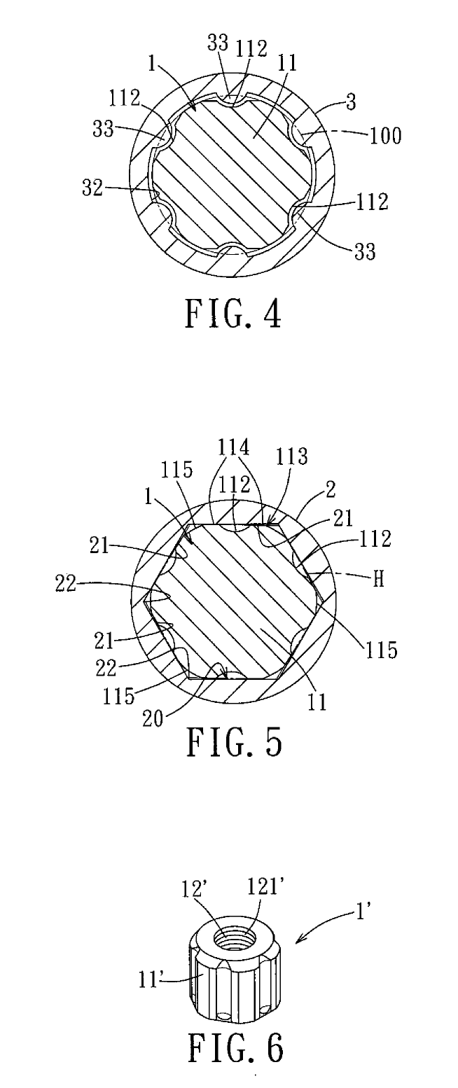

In this embodiment, an imaginary circumscribed cylinder 100 (see FIG. 2) of the external surrounding surface 110 of the socket-engaging part has a diameter slightly shorter than that of the receiving hole 31 (see FIG. 1) of the spline socket wrench 3. Each of the bridging surface portions 115 of the external surrounding surface 110 is a curved surface and overlaps the imaginary circumscribed cylinder 100 of the external surrounding surface 110. Referring further to FIG. 4, the aforesaid configuration of the socket-engaging part permits the socket-engaging part to be sleeved in the spline socket 3 in a manner that each of the keys 33 of the spline socket 3 is retained in a respective one of the grooves 112 of the socket-engaging part. Therefore, the fastener 1 of the invention can be driven rotatably by the spline socket wrench 3 through the engagement between the socket-engaging part and the spline socket wrench 3.

As shown in FIG. 5, the edges of the grooves 112 and the main surface portions 113 of the external surrounding surface 110 of the socket-engaging part are disposed on an imaginary hexagonal prism (H) that is slightly smaller than the receiving space 23 of the hexagonal socket wrench 2. Such configuration of the socket-engaging part permits the socket-engaging part to be sleeved in the hexagonal socket wrench 2 with each of the bridging surface portions 115 of the external surrounding surface 110 being disposed to face a corner 22 defined by an adjacent pair of the inner surface portions 21 of the hexagonal socket wrench 2. When the hexagonal socket wrench 2 is sleeved on and rotated to drive rotation of the socket-engaging part, one of the edges of each of the grooves 112 and an adjacent one of the planar surface regions 114 contact the respective one of the inner surface portions 21 of the hexagonal socket wrench 2. Therefore, the fastener 1 of the invention can also be driven rotatably by the hexagonal socket wrench 2 through the abutment of the main surface portions 113 of the external surrounding surface 110 of the socket-engaging part against the inner surface portions 21 of the hexagonal socket wrench 2.

As shown in FIG. 6, the second preferred embodiment of the fastener 1′ according to the present invention differs from the previous embodiment in that the fastener 1′ is configured as a nut having an internally threaded part 12′ that serves as the securing part, and an external part 11′ that serves as the socket-engaging part. An internal screw thread 121′ is formed on an inner surface of the internally threaded part 12′ radially opposite to the external part 11′. The second preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fastener adapted to be driven rotatably by any one of a spline socket wrench and a hexagonal socket wrench, the spline socket wrench having an annular inner surface that defines a receiving hole, and a plurality of angularly spaced-apart keys that protrude in radial inward directions from the annular inner surface, the hexagonal socket wrench having six inner surface portions that cooperatively define a hexagonal receiving space, said fastener comprising:
a socket-engaging part having
an external surrounding surface that surrounds an axis and that has at least one planar surface region, and
a plurality of angularly spaced-apart grooves that are formed in said external surrounding surface and that extend parallel to the axis, one of said grooves being formed adjacent to said planar surface region, each of said grooves having opposite edges parallel to the axis;
wherein said edges of said grooves and said planar surface region are disposed on an imaginary hexagonal prism slightly smaller than the receiving space of the hexagonal socket wrench, thereby permitting said socket-engaging part to be sleeved in the hexagonal socket wrench;
wherein one of said edges of each of said grooves is adapted to contact a respective one of the inner surface portions of the hexagonal socket wrench, and said planar surface region is adapted to contact one of the inner surface portions of the hexagonal socket wrench when the hexagonal socket wrench is sleeved on and rotated to drive rotation of said socket-engaging part; and
wherein an imaginary circumscribed cylinder of said external surrounding surface has a diameter slightly shorter than that of the receiving hole of the spline socket wrench, thereby permitting said socket-engaging part to be sleeved in the spline socket wrench in a manner that each of the keys of the spline socket wrench is retained in a respective one of said grooves of said socket-engaging part; and
a securing part connected to said socket-engaging part and formed with a screw thread.

2. The fastener as claimed in claim 1, wherein said external surrounding surface of said socket-engaging part has a plurality of main surface portions formed respectively with said grooves, each of said main surface portions having at least one of said planar surface region that is formed circumferentially adjacent to a corresponding one of said grooves, and that is adapted to contact a respective one of the inner surface portions of the hexagonal socket wrench when the hexagonal socket wrench is sleeved on and rotated to drive rotation of said socket-engaging part.

3. The fastener as claimed in claim 2, wherein each of said main surface portions of said external surrounding surface of said socket-engaging part has a pair of said planar surface regions formed at circumferentially opposite sides of the corresponding one of said grooves, one of said edges of each of said grooves and an adjacent one of said planar surface regions being adapted to contact the respective one of the inner surface portions of the hexagonal socket wrench when the hexagonal socket wrench is sleeved on and rotated to drive rotation of said socket-engaging part.

4. The fastener as claimed in claim 2, wherein said fastener is configured as a bolt having a bolt head that serves as said socket-engaging part, and a shank segment that serves as said securing part, said screw thread being an external screw thread that is formed on an outer surface of said shank segment.

5. The fastener as claimed in claim 2, wherein said fastener is configured as a nut having an internally threaded part that serves as said securing part, and an external part that is formed integrally around said internally threaded part and that serves as said socket-engaging part, said screw thread being an internal screw thread that is formed on an inner surface of said internally threaded part radially opposite to said external part.

6. The fastener as claimed in claim 2, wherein the hexagonal socket wrench includes an inner surface having the six inner surface portions, said external surrounding surface of said socket-engaging part further having a plurality of bridging surface portions, each of said bridging surface portions interconnecting an adjacent pair of said main surface portions of said external surrounding surface and being disposed to face a corner defined by an adjacent pair of the inner surface portions of the inner surface of the hexagonal socket wrench when the hexagonal socket wrench is sleeved on said socket-engaging part.

7. The fastener as claimed in claim 3, wherein the hexagonal socket wrench includes an inner surface having the six inner surface portions, said external surrounding surface of said socket-engaging part further having a plurality of bridging surface portions, each of said bridging surface portions interconnecting an adjacent pair of said main surface portions of said external surrounding surface and being disposed to face a corner defined by an adjacent pair of the inner surface portions of the inner surface of the hexagonal socket wrench when the hexagonal socket wrench is sleeved on said socket-engaging part.

8. The fastener as claimed in claim 4, wherein the hexagonal socket wrench includes an inner surface having the six inner surface portions, said external surrounding surface of said socket-engaging part further having a plurality of bridging surface portions, each of said bridging surface portions interconnecting an adjacent pair of said main surface portions of said external surrounding surface and being disposed to face a corner defined by an adjacent pair of the inner surface portions of the inner surface of the hexagonal socket wrench when the hexagonal socket wrench is sleeved on said socket-engaging part.

9. The fastener as claimed in claim 5, wherein the hexagonal socket wrench includes an inner surface having the six inner surface portions, said external surrounding surface of said socket-engaging part further having a plurality of bridging surface portions, each of said bridging surface portions interconnecting an adjacent pair of said main surface portions of said external surrounding surface and being disposed to face a corner defined by an adjacent pair of the inner surface portions of the inner surface of the hexagonal socket wrench when the hexagonal socket wrench is sleeved on said socket-engaging part.

10. The fastener as claimed in claim 6, wherein each of said bridging surface portions of said external surrounding surface of said socket-engaging part is a curved surface and overlaps the imaginary circumscribed cylinder of said external surrounding surface.

11. The fastener as claimed in claim 7, wherein each of said bridging surface portions of said external surrounding surface of said socket-engaging part is a curved surface and overlaps the imaginary circumscribed cylinder of said external surrounding surface.
